(19) United States
(12) Patent Application Publication
(10) Pub. No.: US 2024/0147258 A1
(43) Pub. Date: May 2, 2024

(54) BASE STATION CONTROL APPARATUS, BASE STATION CONTROL METHOD, AND RECORDING MEDIUM RECORDING PROGRAM

(71) Applicant: NEC Corporation, Minato-ku, Tokyo (JP)

(72) Inventor: Kazuki Ogata, Tokyo (JP)

(73) Assignee: NEC Corporation, Minato-ku, Tokyo (JP)

(21) Appl. No.: 18/279,355

(22) PCT Filed: Mar. 2, 2021
(86) PCT No.: PCT/JP2021/007815

§ 371 Date: Aug. 29, 2023

(51) Int. Cl. H04W 24/02; H04W 24/04

(52) U.S. Cl. CPC H04W 24/02; H04W 24/04

(57) ABSTRACT

A base station control apparatus includes a part that acquires a provision state of a predetermined service by one or more base stations in a service target area; and a part that instructs the one or more base stations whether or not to provide the predetermined service based on a service coverage which indicates a ratio of one or more areas in which the predetermined service is provided by the one or more base stations for each road section included in the service target area.

This application is a National Stage Entry of PCT/JP2021/007815 filed on Mar. 2, 2021, the contents of all of which are incorporated herein by reference, in their entirety.

### FIELD

The present invention relates to a base station control apparatus, a base station control method, and a recording medium recording a program.

### BACKGROUND

“A population coverage rate” has been used as an index regarding largeness of coverage in which telecommunications carriers can provide services, but in recent years, evaluation using a mesh scheme has become widely used. For example, in a frequency allocation for the fifth-generation mobile communication system (hereinafter referred to as “5G”), Ministry of Internal Affairs and Communications divided whole of the country into 10 km square meshes and requires to widely cover areas having business potential regardless of urban areas or regional areas. As a concrete numerical target, it is required to arrange 5G advanced specific base stations in 50% or more meshes in five years across the country and by each regional block.

Patent Literature (PTL) 1 discloses a method for determining placement of base stations based on resources of all the base stations arranged in a certain area when placement of the base stations is determined in the corresponding area (above described a mesh).

PTL 2 discloses a backup power supply system which can extend a backup time length while reducing a cost to be expended for the backup power supply by appropriately controlling power consumption of a load (a base station) and an output of the backup power supply.

PTL 3 discloses a power demand control apparatus of a communication facility which can utilize a storage battery of the communication facility. The power demand control apparatus has a function to detect a certain communication base station whose traffic is less than or equal to a predetermined value among a plurality of the communication base stations and to make its storage battery be discharged to a transmission and distribution network side.

PTL 4 discloses a mobile terminal apparatus which can prevent battery drain in an out-of-service area where radio waves cannot be received or in an area where radio waves are weak.
PTL 1: Japanese Patent Kokai Publication No: 2007-235831
PTL 2: Japanese Patent Kokai Publication No: 2015-70785
PTL 3: Japanese Patent Kokai Publication No: 2017-70159
PTL 4: Japanese Patent Kokai Publication No: 2013-106065

### SUMMARY

The following analysis has been made by the present inventor. As described in the background art, in variety of services provided by each telecommunications carrier, installation of the base stations is proceeded in a direction of widely covering areas where there may exist customers. As indicated in examination criteria at the time a frequency allocation for above the 5G, however, it is sufficient that a base station having a particular function is placed in a certain mesh and it is not required that the communication service concerned can be used in all the positions in the mesh.

Meanwhile, base stations installed by each telecommunications carrier are utilized as an infrastructure to realize IoT (Internet of Things) and connected cars. By taking existence of these moving terminals under consideration, it is required to continuously provide services.

To meet these kinds of requirements, as described in PTL 1, it is considered that base stations are placed to thoroughly cover at least areas where these mobbing objects can move. However, in the case where high straightness (low wrapping around) frequency bands are used or in the case where a service cell size is restricted due to rule of law, or the like, it is necessary to install a lot of base stations whereby a problem of a high cost arises.

It is an object of the present invention to provide a base station control apparatus, a base station control method, and a recording medium recording a program which can provide services in a way that is suitable for services for IoT or connected cars with a limited number of base stations.

According to a first aspect, there is provided a base station control apparatus, including:
a part that acquires a provision state of a predetermined service by one or more base stations in a service target area; and
a part that instructs the one or more base stations whether or not to provide the predetermined service based on a service coverage which indicates a ratio of one or more areas in which the predetermined service is provided by the one or more base stations for each road section included in the service target area.

According to a second aspect, there is provided a base station control method, including:
acquiring a provision state of a predetermined service by the one or more base stations in a service target area; and instructing the one or more base stations whether or not to provide the predetermined service based on a service coverage which indicates a ratio of one or more areas in which the predetermined service is provided by the one or more base stations for each road section included in the service target area. This method is associated with a certain machine, which is a control apparatus to instruct the one or more base stations whether or not to provide the predetermined service.

According to a third aspect, there is provided a computer program (hereinafter, a “program”) for realizing the functions of the above control apparatus. This computer program is inputted to a computer apparatus via an input device or a communication interface from outside, is stored in a storage device, and drives a processor in accordance with predetermined steps or processing. In addition, this program can display, as needed, a processing result including an intermediate state per stage on a display device or can communicate with outside via the communication interface. As an example, the computer apparatus for this purpose typically includes a processor, a storage device, an input device, a communication interface, and as needed, a display device, which can be connected to each other via a bus. In addition, this program can be recorded in a computer-readable (non-transitory) storage medium. That is to say, the present invention can be realized by a computer program product.

According to the present invention, it is possible to provide services in a way that is suitable for services for IoT or connected cars with a limited number of base stations.

### BRIEF DESCRIPTION OF DRAWINGS

FIG. 1 is a diagram illustrating a configuration according to an example embodiment of the present invention.

FIG. 2 is a diagram illustrating an operation according to the example embodiment of the present invention.

FIG. 3 is a diagram illustrating a system configuration according to a first example embodiment of the present invention.

FIG. 4 is a diagram illustrating a relationship between placements of one or more base stations which are control targets of a control apparatus and sections according to the first example embodiment of the present invention.

FIG. 5 is a diagram illustrating an example of base station information held by the control apparatus according to the first example embodiment of the present invention.

FIG. 6 is a diagram illustrating an example of base station information held by the control apparatus according to the first example embodiment of the present invention.

FIG. 7 is a diagram illustrating an example of a service provision policy held by the control apparatus according to the first example embodiment of the present invention.

FIG. 8 is a sequence diagram illustrating an operation of the control apparatus according to the first example embodiment of the present invention.

FIG. 9 is a diagram illustrating an example of an operating state of the one or more base stations which received instructions from the control apparatus according to the first example embodiment of the present invention.

FIG. 10 is a diagram illustrating an operation of the control apparatus according to the first example embodiment of the present invention.

FIG. 11 is a diagram illustrating an operation of the control apparatus according to the first example embodiment of the present invention.

FIG. 12 is a diagram illustrating an example of a service provision policy held by a control apparatus according to a second example embodiment of the present invention.

FIG. 13 is a diagram illustrating an example of an operating state of the one or more base stations which received instructions from the control apparatus according to the second example embodiment of the present invention.

FIG. 14 is a diagram illustrating another example of a service provision policy held by the control apparatus according to the second example embodiment of the present invention.

FIG. 15 is a diagram illustrating another example of an operating state of the one or more base stations which received instructions from the control apparatus according to the second example embodiment of the present invention.

FIG. 16 is a diagram illustrating a system configuration according to a third example embodiment of the present invention.

FIG. 17 is a diagram illustrating an example of a service provision policy held by a control apparatus according to the third example embodiment of the present invention.

FIG. 18 is a sequence diagram illustrating an operation of the control apparatus according to the third example embodiment of the present invention.

FIG. 19 is a diagram illustrating an operation of the control apparatus according to the third example embodiment of the present invention.

FIG. 20 is a diagram illustrating an example of an operating state of the one or more base stations which received instructions from the control apparatus according to the third example embodiment of the present invention.

FIG. 21 is a diagram illustrating a configuration of a computer which can function as a control apparatus of the present invention.

### EXAMPLE EMBODIMENTS

First, an outline of an example embodiment of the present invention will be described with reference to drawings. Note, in the following outline, reference signs of the drawings are denoted to each element as an example for the sake of convenience to facilitate understanding and description of this outline is not intended to any limitation. An individual connection line between blocks in the drawings, etc., referred to in the following description includes both one-way and two-way directions. A one-way arrow schematically illustrates a principal signal (data) flow and does not exclude bidirectionality. In addition, although a port or an interface is present at an input/output connection point of an individual block in the relevant drawings, illustration of the port or the interface is omitted. A program is executed via a computer apparatus, and the computer apparatus includes, for example, a processor, a storage device, an input device, a communication interface, and as needed, a display device. In addition, this computer apparatus is configured such that the computer apparatus can communicate with its internal device or an external device (including a computer) via the communication interface in a wired or wireless manner. In addition, although a port or an interface is present at an input/output connection point of an individual block in the relevant drawings, illustration of the port or the interface is omitted.

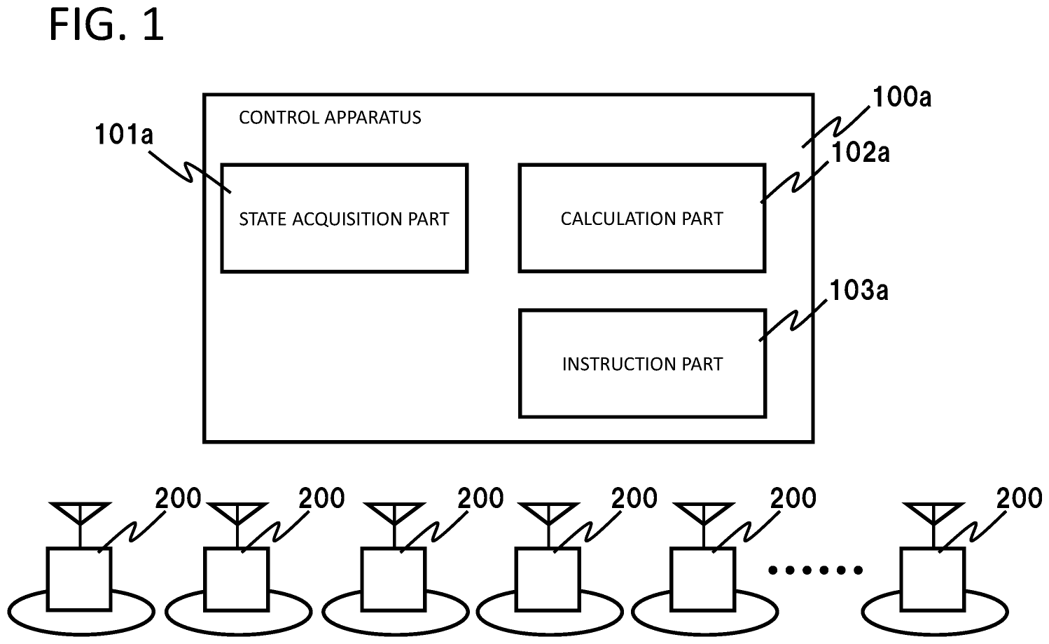

In an example embodiment, as illustrated in FIG. 1, the present invention can be realized by a control apparatus 100a which includes a state acquisition part 101a, a calculation part 102a, and an instruction part 103a.

The state acquisition part 101a functions as a part that acquires a provision state of a predetermined service by one or more base stations for each road section included in a service target area.

The calculation part 102a and the instruction part 103a function as a part that instructs the one or more base stations whether or not to provide the predetermined service based on a service coverage which indicates a ratio of one or more areas in which the predetermined service is provided for the road section.

Next, an operation of the present example embodiment will be described in detail with reference to drawings. The state acquisition part 101a acquires a provision state of a predetermined service by one or more base stations 200 in the service target area. As a method for acquiring of the provision state of the predetermined service, a method of acquiring information from each of the one or more base stations 200 by the control apparatus 100a or a method of acquiring information from a control function of a network side can be adopted. As the predetermined service, provision of various information from the one or more base stations 200 or a data upload service via the one or more base stations 200, or the like can be exemplified.

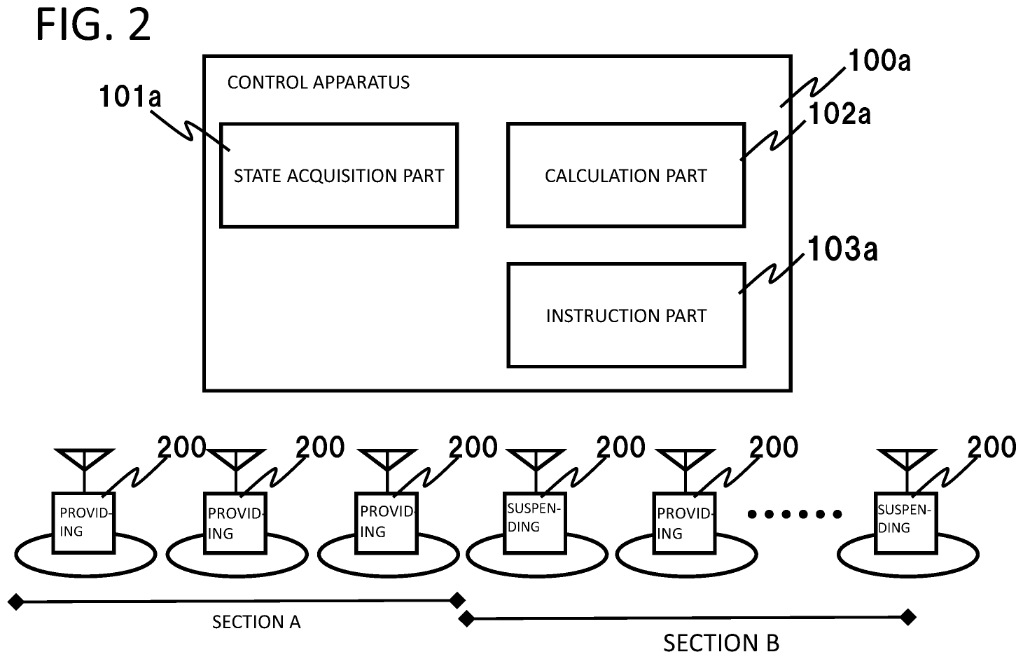

The calculation part 102a calculates a service coverage which indicates a ratio of one or more areas in which the predetermined service is provided by the one or more base stations 200 for each road section included in the service target area. Here, as described in a lower part of FIG. 2, the explanation is made by assuming that the service coverage is respectively calculated for a section A and a section B of the road.

The instruction part 103a instructs the one or more base stations 200 whether or not to provide the predetermined service based on the service coverage. For example, in an example of FIG. 2, because all the base stations 200 in the section A are providing the predetermined service, a service coverage for the predetermined service is calculated as 100%. Here, for example, if a target service coverage for the section A is more than or equal to 60%, the instruction part 103a selects one base station 200 belonging to the section A and may instruct it to suspend the provision of the service. As a result, power consumption of the base station 200 in the section A can be reduced.

Furthermore, in the example of FIG. 2, some base stations 200 among the base stations 200 in the section B are in the state of suspending the provision of the predetermined service, the service coverage for the predetermined service is calculated as less than 100%. Here, for example, if a target coverage for the section B is 100%, the instruction part 103a selects one or more base stations in the state of suspending the provision of the service among the one or more base stations 200 belonging to the section B and instructs to start the provision of the service. As a result, it is possible to improve convenience of users receiving the service from the one or more base stations 200 in the section B and Quality of Experience of the service.

As described above, the control apparatus 100a of the present example embodiment controls the provision of the service by the one or more base stations 200 in units of sections arbitrarily set on the road. As a result, it makes possible to optimize services for vehicles moving on roads, pedestrians, IoT terminals, unmanned carriers, Unmanned Arial Vehicles, or robots. In addition, as described above, because it makes possible to control the power consumption of the base station 200 to be reduced, it makes possible to improve a power saving performance of a whole system.

### First Example Embodiment

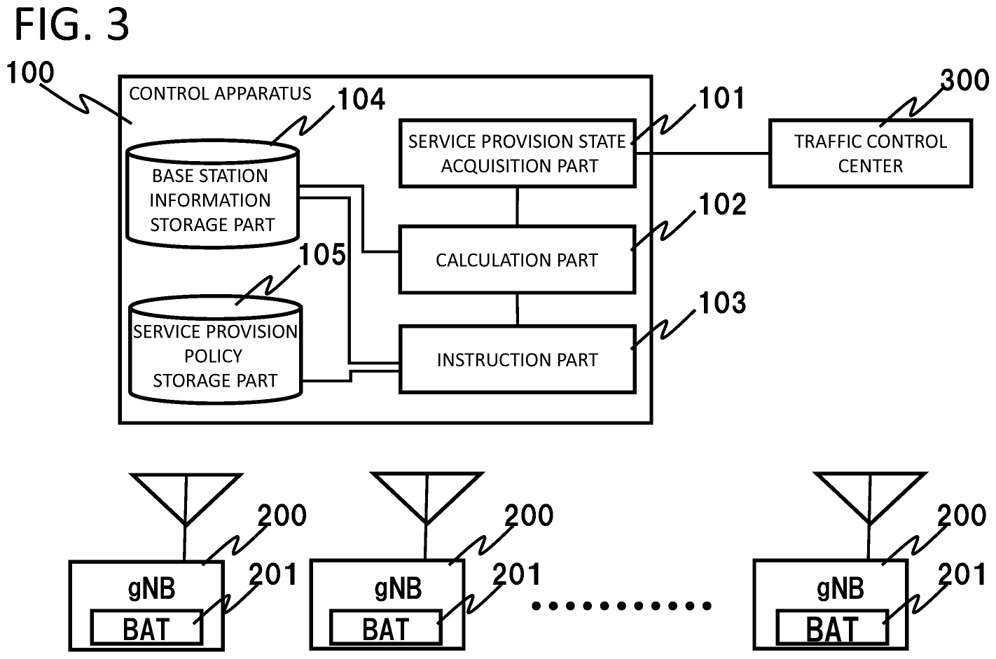

Next, a first example embodiment of the present invention will be described in detail with reference to drawings. FIG. 3 is a diagram illustrating a system configuration according to the first example embodiment of the present invention. With reference to FIG. 3, a control apparatus 100 which includes a service provision state acquisition part 101, a calculation part 102, an instruction part 103, a base station information storage part 104, and a service provision policy storage part 105 and controls one or more base stations (gNB (a next generation Node B)) 200 is shown.

The service provision state acquisition part 101 acquires a provision state of the predetermined service in the one or more base stations 200 through a traffic control center 300. Hereinafter, the present example embodiment will be described by assuming that the one or more base stations 200 are placed at intersections and provides safe deriving assistance information, such as “traffic light oversight prevention assistance”, “crossing collision prevention assistance”, and “rear-end collision prevention assistance”, or the like, to vehicles and pedestrians under control of the traffic control center 300.

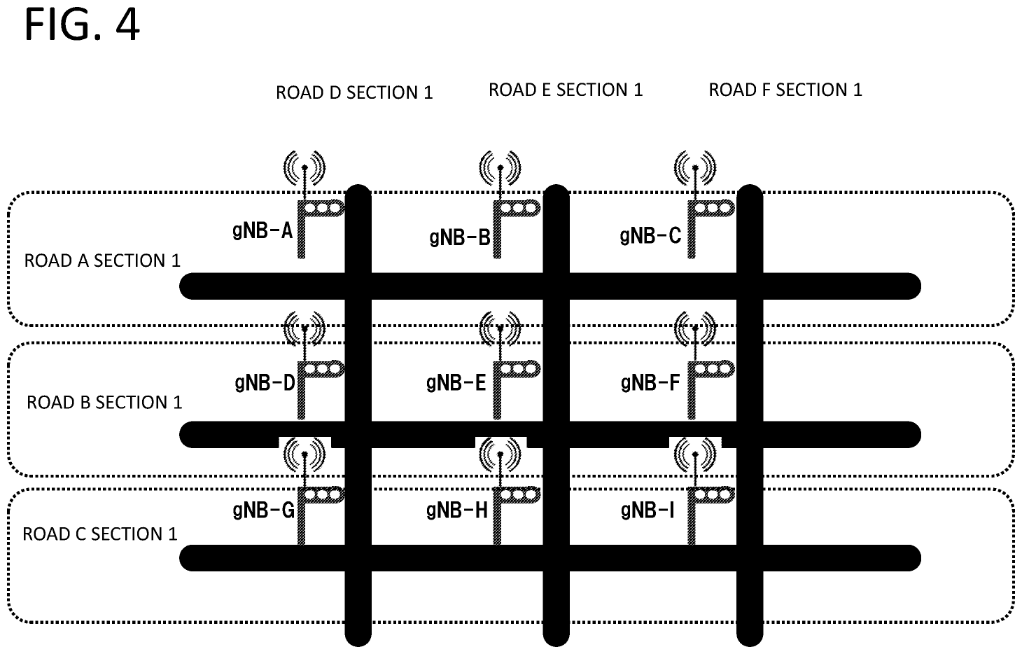

FIG. 4 is a diagram illustrating a relationship between placements of the one or more base stations 200 and road sections in a service target area of the control apparatus 100 according to the present example embodiment. Hereinafter, in the present example embodiment, it is assumed that base stations gNB-A to gNB-I are placed on the traffic lights at the intersections of the roads as shown in FIG. 4. Furthermore, it is assumed that a road section at which base stations gNB-A to gNB-C are placed is a road A section 1, a road section at which base stations gNB-D to gNB-F are placed is a road B section 1, and a road section at which base stations gNB-G to gNB-I are placed is a road C section 1. Similarly, road sections in a vertical direction of FIG. 4 are a road D section 1, a road E section 1, and a road F section 1 in a direction from left to right.

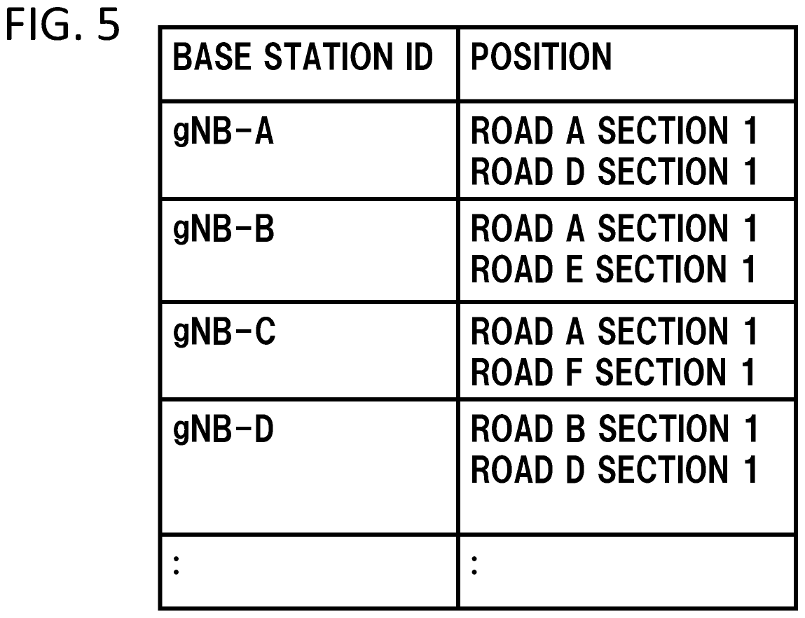

The base station information storage part 104 stores base station information including road sections to which the base stations as shown in FIG. 4 belong. FIG. 5 is a diagram illustrating an example of base station information held by the base station information storage part 104. In the example of FIG. 5, an ID of each base station and information on a road and a section as a position to which each base station belongs are stored in association with each other. Note, in the example of FIG. 5, as the position of each base station, the road and the section are set, but information as to which position in the section each base station is located at may be held. For example, because the base station gNB of FIG. 4 is located at the respective starting points of the road A section 1 and the road D section 1, information such as the starting point of the road A section 1 and the starting point of the road D section 1 may be held.

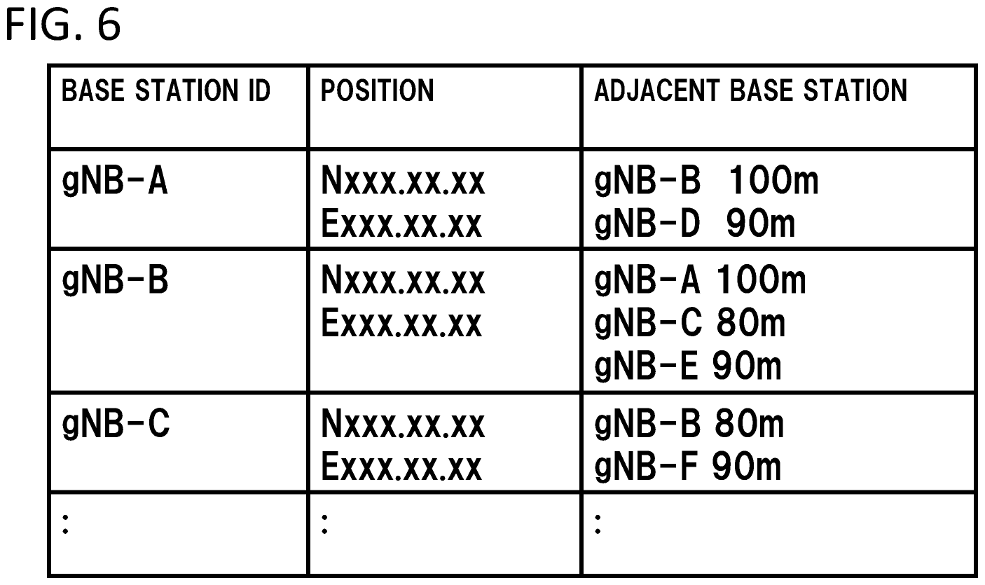

Furthermore, the base station information held by the base station information storage part 104 may be a mode including position information of the base station by coordinate information as shown in FIG. 6. In this case, it may be possible to determine which section of which road each base station belongs to by matching with coordinate information of each road and each section which is separately held. As this base station information, it is possible to use base station information which is held by each telecommunications carrier for maintenance of base stations. Furthermore, in a more suitable example embodiment, as shown in an adjacent base station column of FIG. 6, a base station adjacent to each base station and a distance therebetween may be held. By holding such information, placement distances of the one or more base station in each section can be grasped.

The calculation part 102 calculates, for each road section as shown in FIG. 4, a service coverage which indicates a ratio of one or more areas in which the safe deriving assistance information is provided by the one or more base stations 200. Note, this service coverage can be obtained from a ratio of a length of the section where the service is provided by the one or more base stations 200 to a whole length of each section of the road as a simple method. Of course, it can be obtained from a ratio of a dimension of an area where the service is currently provided to a dimension of the maximum service area in which all the base stations 200 located at each section of the road are placed.

The instruction part 103 determines whether or not to make the one or more base stations located at each road section provide a service using the calculated service coverage and a service provision policy storage part 105 and instructs the one or more base stations 200 as to the service.

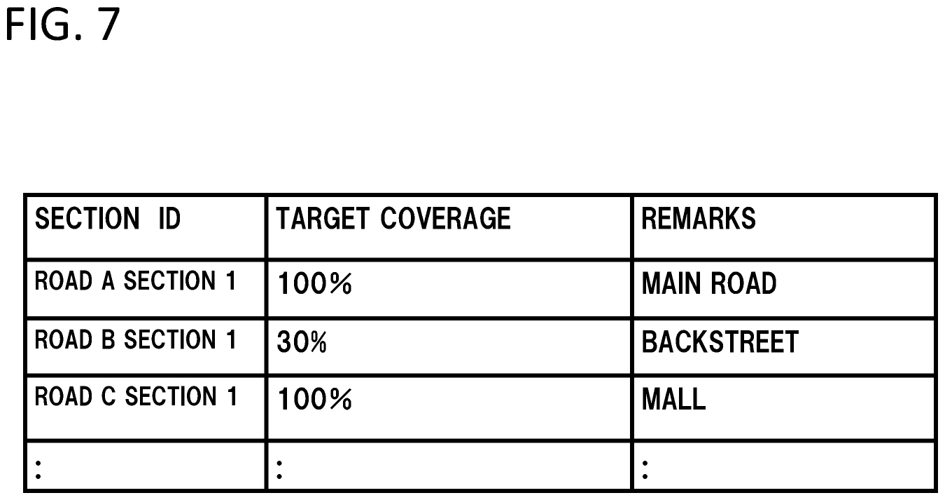

FIG. 7 is a diagram illustrating an example of a service provision policy held by the control apparatus 100. With reference to FIG. 7, an example of a service provision policy in which a taeget service coverage is set for each section of each road is shown. For example, because the road A section 1 is a main road as described in remarks column, the target service coverage is set to 100%. In this case, the instruction part 103 controls the one or more base stations in such way that the service coverage of the road A section 1 becomes to be 100%. Because the road B section 1 is a backstreet as described in remarks column and a low service coverage may be allowed due to less traffic than that of other road, the target service coverage is set to 30%. In this case, the instruction part 103 controls the one or more base stations in such way that the service coverage of the road B section 1 becomes to be 30%. As a result, in the road B section 1, a service provided by the one or more base stations 200 is partly suspended.

Note, the service provision policy as shown in FIG. 7 is just one example and a policy can be created according to a service content or a position of the section of the road. For example, the target coverage is not necessarily one value per one section and a different values can be set for each service provided by the one or more base stations 200. For example, for a road section, a target coverage may be set to 100% for a safe deriving assistance information provision service and a target coverage may be set to 70% for a destination recommendation service which is less important than the safe deriving assistance information.

One or more base stations (gNB) 200 are base stations of the fifth-generation mobile communication system installed by telecommunications carriers. In 5G NR (New Radio) developed for the fifth-generation mobile communication system by 3GPP (3rd Generation Partnership Project), it is described to use two frequency bands. A first frequency band is a frequency band from 450 MHz to 6 GHz which is referred to as FR1 (Frequency Range 1) or sub 6 GHz (sub6) in Japan. A second frequency band is a frequency band from 24.250 GHz to 52.600 GHz which is referred to as FR2 (Frequency Range 2). The present example embodiment will be described by assuming that the one or more base stations (gNB) 200 are base stations which provide services by FR2 that is also referred to as a millimeter waveband. In addition, although an explanation will be made by assuming that the one or more base stations (gNB) 200 are base stations installed by telecommunications carriers, they may be base stations of a network operated by a local government or the like other than the telecommunications carriers referred to as local 5G.

Furthermore, the base station (gNB) 200 includes a backup power supply (BAT) 201 and can operate using the backup power supply (BAT) 201 in a case of a power outage. As a backup power supply (BAT) 201, a secondary battery such as a second a lead battery or a lithium-ion battery, or the like, can be used. The backup power supply (BAT) 201 can also concurrently use a fuel cell such as a hydrogen battery as described in PTL 2.

The traffic control center 300 instructs the one or more base stations 200 to provide the safe deriving assistance information. In addition, the traffic control center 300 provides a control apparatus 100 with a state of provision of the safe deriving assistance information by the one or more base stations 200.

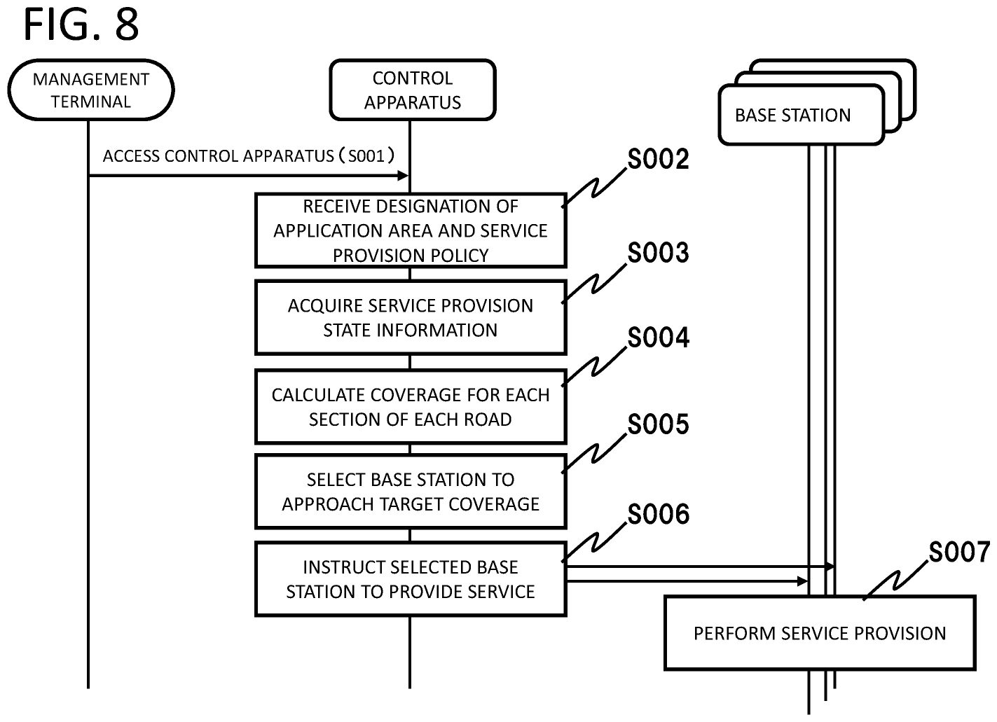

Next, an operation of the present example embodiment will be described in detail with reference to drawings. FIG. 8 is a sequence diagram illustrating an operation of the control apparatus according to the first example embodiment of the present invention. With reference to FIG. 8, an administrator accesses the control apparatus 100 from a management terminal and starts various settings (step S001).

The control apparatus 100 receives designation of an area (application area) in which the one or more base station (gNB) 200 exists which are control targets and a service provision policy from the administrator who operates the management terminal (step S002). In the following description, it is assumed that an area as shown in FIG. 4 is designated and a service provision policy as shown in FIG. 7 is set as a service provision policy. Note, when the control apparatus 100 receives the designation of the area (application area) in which the one or more base station (gNB) 200 exists which are control targets, the control apparatus 100 may provide the administrator with an overview of the area (positions of the one or more base stations, a current service provision state, and so on) which is a control target. Furthermore, the control apparatus 100 may receive designations of a threshold value used for the service provision policy and start timings of operations of the one or more base stations from the administrator when the control apparatus 100 receives the designation of the application area or the settings of the service provision policy.

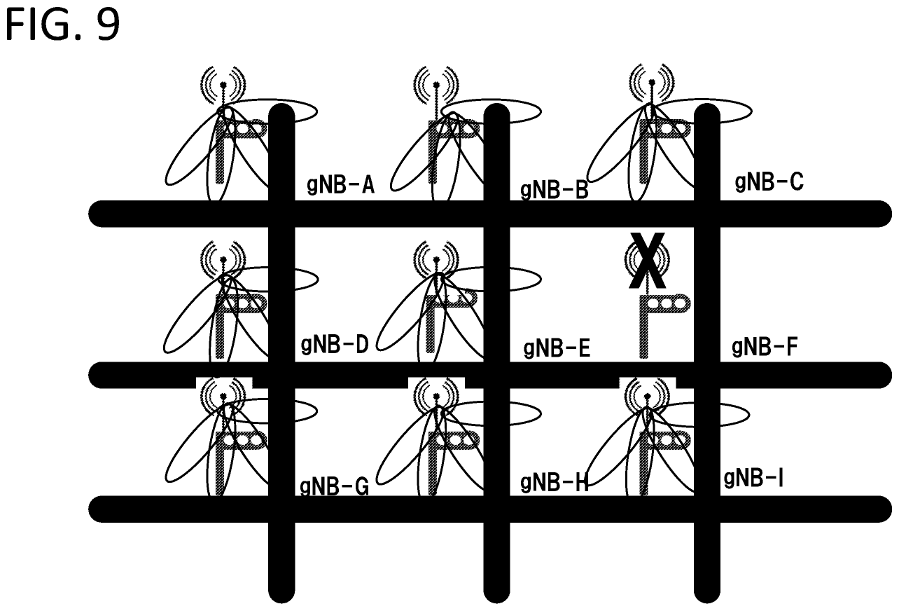

Next, the control apparatus 100 acquires a service provision state from the traffic control center 300 (step S003). Here, the explanation will be described by assuming that information that the base station gNB-F having an X mark among the base stations gNB-A to gNB-I is suspending a service, and other base stations are providing the services, as shown in FIG. 9, is obtained.

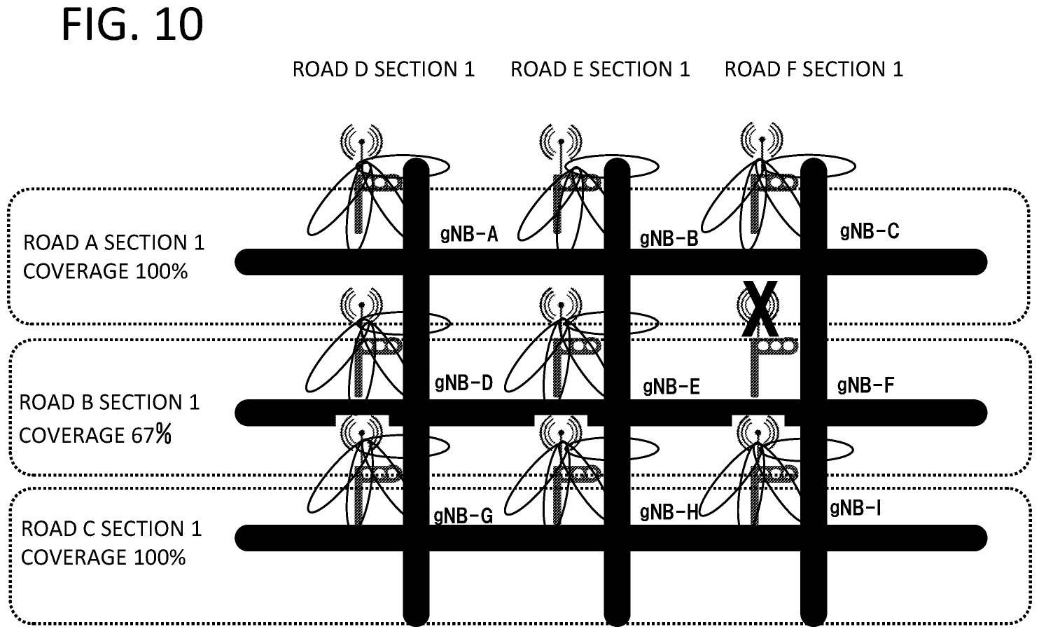

Next, the control apparatus 100 calculates a coverage by each road section using the service provision state obtained (step S004). A coverage of the road A section 1 of FIG. 10 to which the base stations gNB-A to gNB-C belong, a coverage of the road B section 1 to which the base stations gNB-D to gNB-F belong, and a coverage of the road C section 1 to which the base stations gNB-G to gNB-I belong are respectively calculated to be 100%, 67%, and 100%. Note, the coverages for the road D section 1 to the road F section 1 in a vertical direction of FIG. 10 may also be calculated although they are omitted in FIG. 10.

Next, the control apparatus 100 compares the calculated coverage with a target coverage set in the service provision policy. As a result of the comparison, when the calculated coverage falls within a predetermined range with respect to the target coverage, the control apparatus 100 determines that the service provision state of the one or more base stations in the corresponding road section satisfies the service provision policy. On the other hand, when the calculated coverage is significantly higher than the target coverage or the calculated coverage is significantly lower than the target coverage, the control apparatus 100 attempt to adjust the service provision state of the one or more base stations for the corresponding road sections. Concretely, when the calculated coverage is significantly higher than the target coverage, the control apparatus 100 selects one or more base stations to suspend provision of the service among the one or more base stations providing the service. Conversely, when the calculated coverage is significantly lower than the target coverage, the control apparatus 100 selects one or more base stations to start provision of the service among the one or more base stations suspending the service. In this way, the control apparatus 100 selects one or more base stations in such way that a coverage for each road0 section approaches a value close to the target value (step S005).

For example, when the service provision policy shown in FIG. 7 and the coverage shown in FIG. 10 are compared with each other, the control apparatus 100 determines that the service provision policy is satisfied because both the coverage of the road A section 1 and the coverage of the road C section 1 are coincident with the target coverage of 100%. On the other hand, because the road B section 1 has an actual coverage of 67% which is significantly higher than the target coverage of 30%, the control apparatus 100 selects one or more base stations to suspend the service. For example, the control apparatus 100 selects the base station gNB-D as a base station to be transited to a service suspending state among the base stations gNB-D and gNB-F which are providing the service belonging to the road B section 1. Note, at the time of selection of one or more base stations to suspend the service or to start the service from a plurality of base stations, it is possible to take a distance to an adjacent base station into consideration. For example, as shown in FIG. 6, when a distance to an adjacent base station is known, for example, it is preferable to select base stations under a predetermined rule such as every other base station or every two base stations, or the like, in order to prevent a section in which the service is not provided from being lengthened, which is caused when base stations providing the service are successively placed or base stations suspending the service are successively placed. Note, when the base stations are placed at intersections, the base station selectin rule may be a rule for selecting every other intersection or every two intersections, or the like.

Next, the control apparatus 100 instructs the selected base station gNB-D to suspend or start the service (step S006).

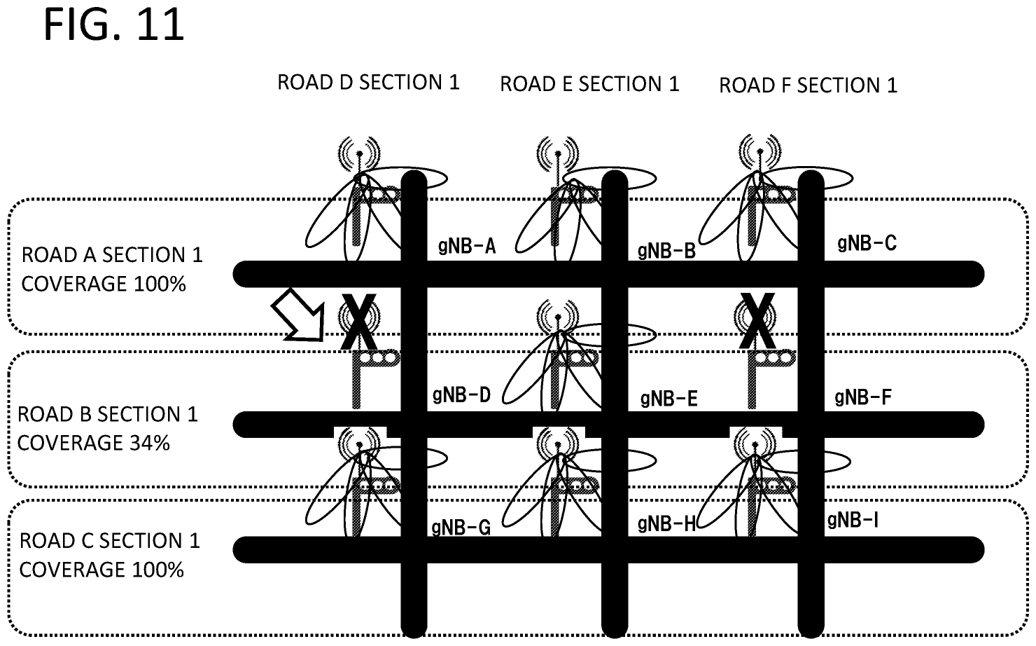

Finally, the base station gNB-D performs to suspend the service according to the instruction from the control apparatus 100 (step S007). By doing this, as shown in FIG. 11, the service coverage of the road B section 1 becomes 34% and, as a result, the service coverage is changed to a value falling within a predetermined range with respect to the target coverage of 30%.

By doing this, the service provision state of the one or more base stations in an area which is a control target is maintained in an intended state in which provision of services for vehicles and pedestrians moving on each road section are taken into consideration.

Furthermore, in the event of a power outage, it is possible to continue a service at one or more base stations in particular road sections by doing a similar control as the operation as described above. On the other hand, it is possible to extend an operation period by a backup power supply by suppressing a service provision of the one or more base stations of the particular road sections. In such case, the control apparatus 100 can determine to suspend or restart the service at the one or more base stations using a service provision policy for the power outage in which a lower target coverage than that for a no power outage (a second target coverage) is set. Such service provision policy may be set in the control apparatus 100 in advance or may be used by performing a predetermined correction to a normal service provision policy.

Note, it is omitted in the above description, when the coverages for the road D section 1 to the road F section 1 in a vertical direction of FIG. 10 may also be calculated, it is possible to continue services for vehicles and pedestrians moving on these road sections, by determining whether or not the service provision policy is satisfied for these road sections in the same way.

### Second Example Embodiment

In the first example embodiment as described above, an example is described, in which the target coverage set in the service provision policy is a fixed value. However, it is possible to switch over and use a plurality of policies in which different target coverages are set. A second example embodiment in which a plurality of policies are switched over and used will be described below. A configuration and operation of the second example embodiment are substantially common to that of the first example embodiment, the differences between them are mainly described.

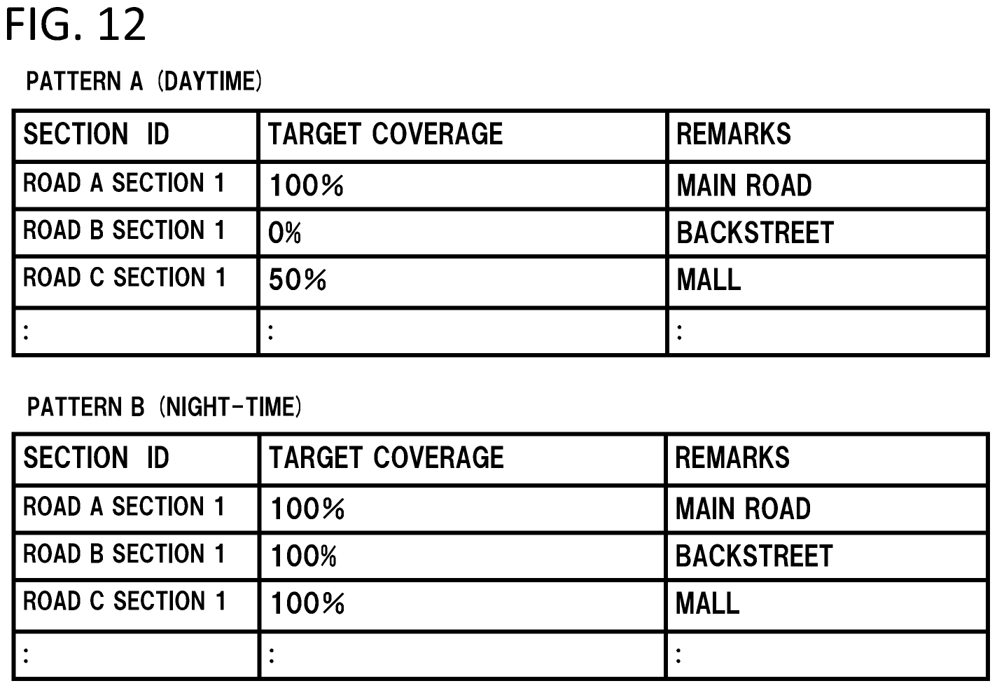

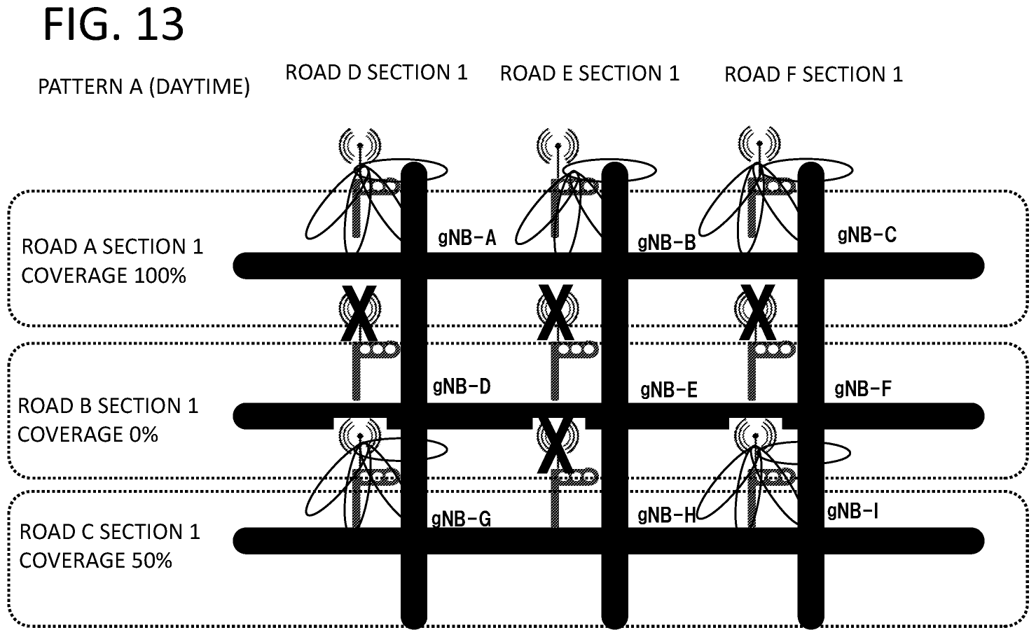

FIG. 12 is a diagram illustrating an example of a service provision policy held by a control apparatus 100 according to the second example embodiment. An upper part of FIG. 12 shows a service provision policy applied during daytime (a pattern A) and a lower part of FIG. 12 shows a service provision policy applied during night-time (a pattern B). In the example shown in FIG. 12, a target coverage of 0% is set to the road B section 1 and a target coverage of 50% is set to the road C section 1 which have low traffic during daytime. By doing this, it is possible to suppress power consumption of one or more base stations in the corresponding road section (refer to FIG. 13).

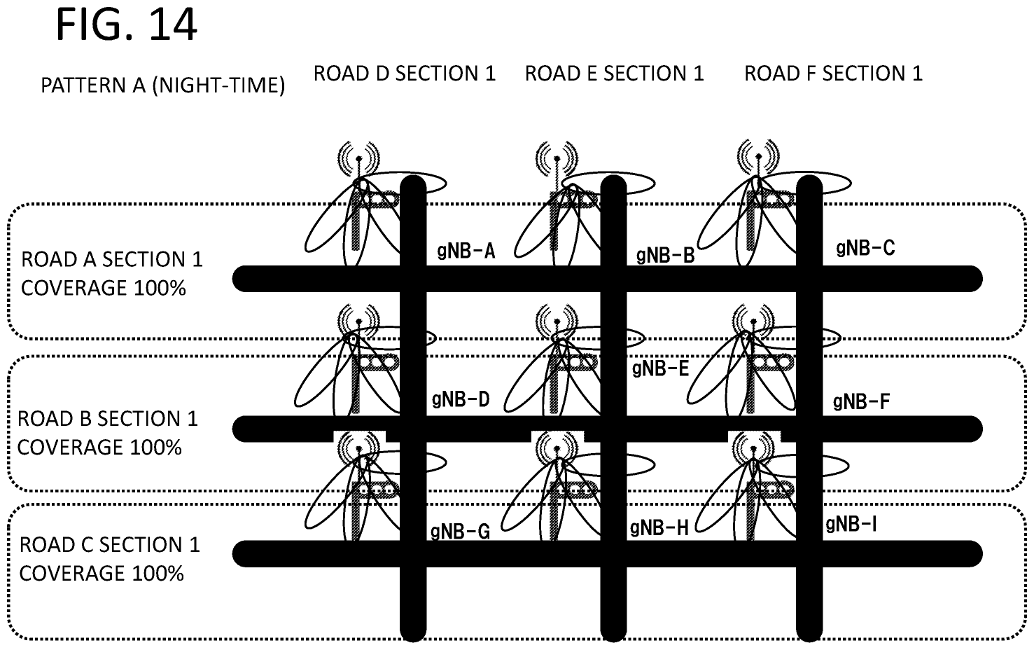

On the other hand, even if the road sections having a low traffic flow during daytime, there is a case where the traffic flow may increase during night-time due to the number of people returning home, and so on. Furthermore, depending on a service provided from one or more base stations, such as a pedestrian watching service, or the like, for the safety reasons, it is assumed that there is a case where it is preferable to provide information thoroughly from the one or more base stations. By this reason, in the example shown in FIG. 12, a target coverage is set to 100% for all of road A section 1 to road C section 1. As a result, as shown in FIG. 14, a service can be provided from the one or more base stations in the whole service provision area.

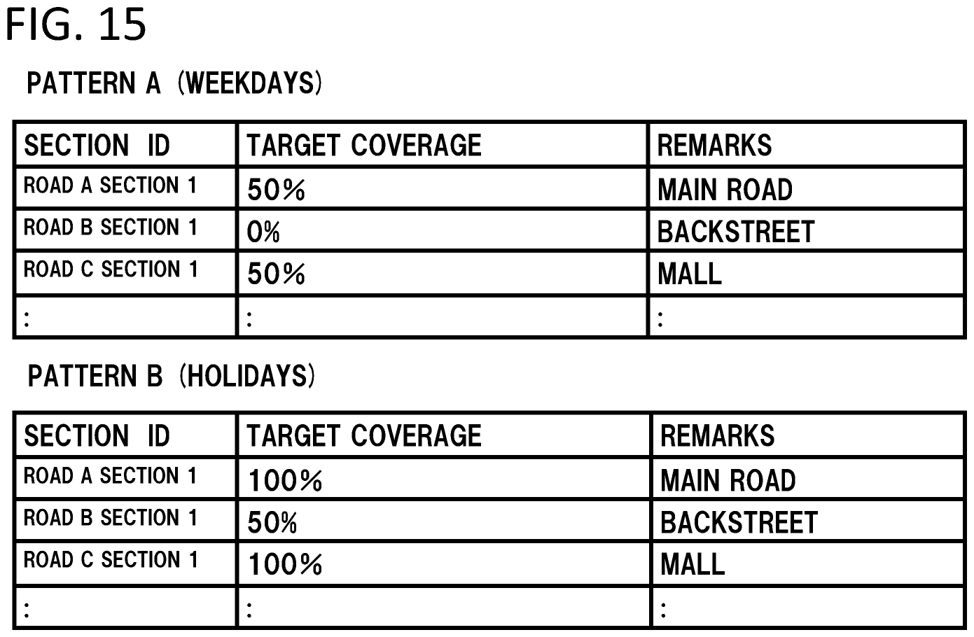

FIG. 15 is a diagram illustrating another example of a service provision policy held by the control apparatus 100 according to the second example embodiment. An upper part of FIG. 15 shows a service provision policy applied during weekdays (a pattern A) and a lower part of FIG. 15 shows a service provision policy applied during holidays (a pattern B). In the example shown in FIG. 15, because traffic flows for weekdays of the road A section 1 to the road C section 1 are low, target coverages of 50%, 0% and 50% are set to the road A section 1 for the road C section, respectively. On the other hand, because traffic flows for holidays of the road A section 1 to the road C section 1 becomes high, target coverages of 100%, 50% and 100% are set for the road A section 1 to the road C section, respectively. As described above. it is possible to employ a configuration in which the service provision policy is switched over based on day of week in place of time of day.

Of course, in addition to switching over between two patterns as shown in FIG. 12 and FIG. 15, it is possible to employ a configuration in which the number of service provision policies according to combinations of time of day, day of week, and service contents are held by the control apparatus 100 and the number of service provision policies are switched over and used.

### Third Example Embodiment

In the first and second example embodiments as described above, it is determined whether or not to make one or more base stations provide service by setting a target coverage. However, it is also possible to determine whether or not to make one or more base stations provide service using elements other than a target coverage. The third example embodiment in which it is determined whether or not to make one or more base stations provide service using traffic flow of a corresponding section in addition to the target coverage will be described below.

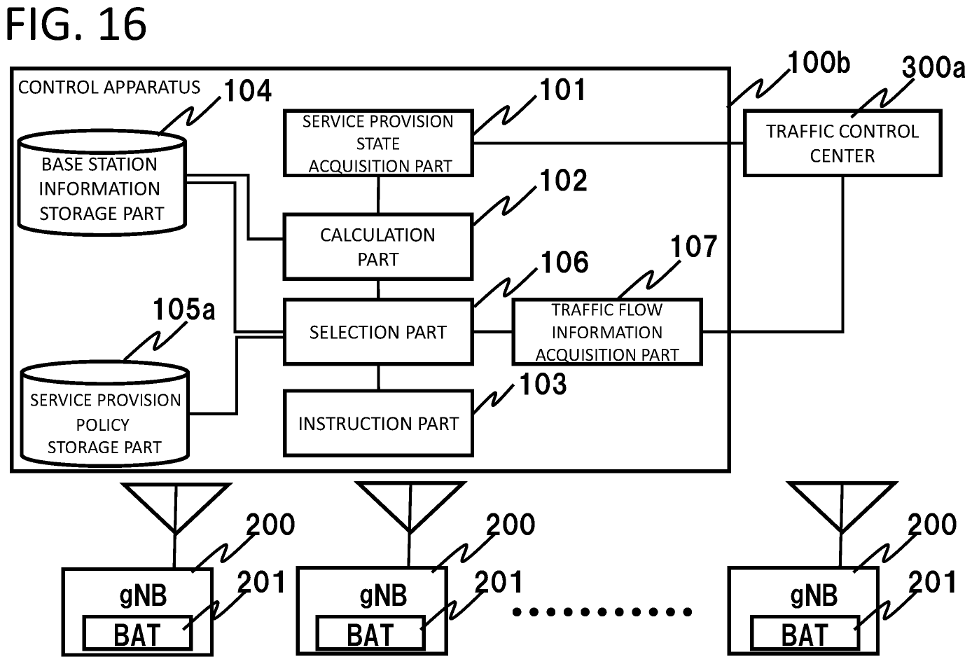

FIG. 16 is a diagram illustrating a system configuration according to the third example embodiment of the present invention. A difference in configuration from the first example embodiment as shown in FIG. 3 is that a selection part 106 and a traffic flow information acquisition part 107 are added to a control apparatus 100b. Because other configurations are substantially the same as those of the first and the second example embodiments, the difference is mainly described below.

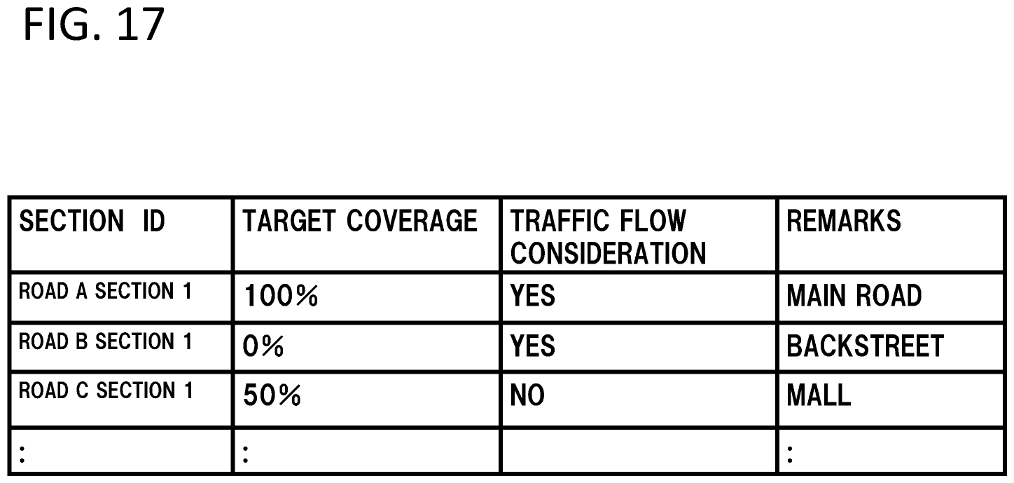

FIG. 17 is a diagram illustrating an example of a service provision policy storage part 105a held by a control apparatus according to the third example embodiment of the present invention. A difference from the service provision policy held by the control apparatus according to the first example embodiment is that “a traffic flow consideration field” is added, which indicates whether or not to determine whether or not to make the one or more base stations provide a service by taking a traffic flow for each road section into consideration.

The traffic flow information acquisition part 107 acquires traffic flow information of a designated road section from a traffic control center 300a. Note, as such traffic flow information, the number of vehicles or pedestrians measured by one or more traffic flow sensors installed at one or more road sections or traffic lights can be used.

For a road section of which the “traffic flow consideration field” as described above is YES, the selection part 106 determines whether or not to make one or more base stations in the corresponding road section provide a service by taking the traffic flow acquired by the traffic flow information acquisition part 107 into consideration.

The traffic control center 300a of the present example embodiment provide the control apparatus 100b with traffic flow information of road sections designated from the control apparatus 100b in addition to the safe deriving assistance information by one or more base stations 200.

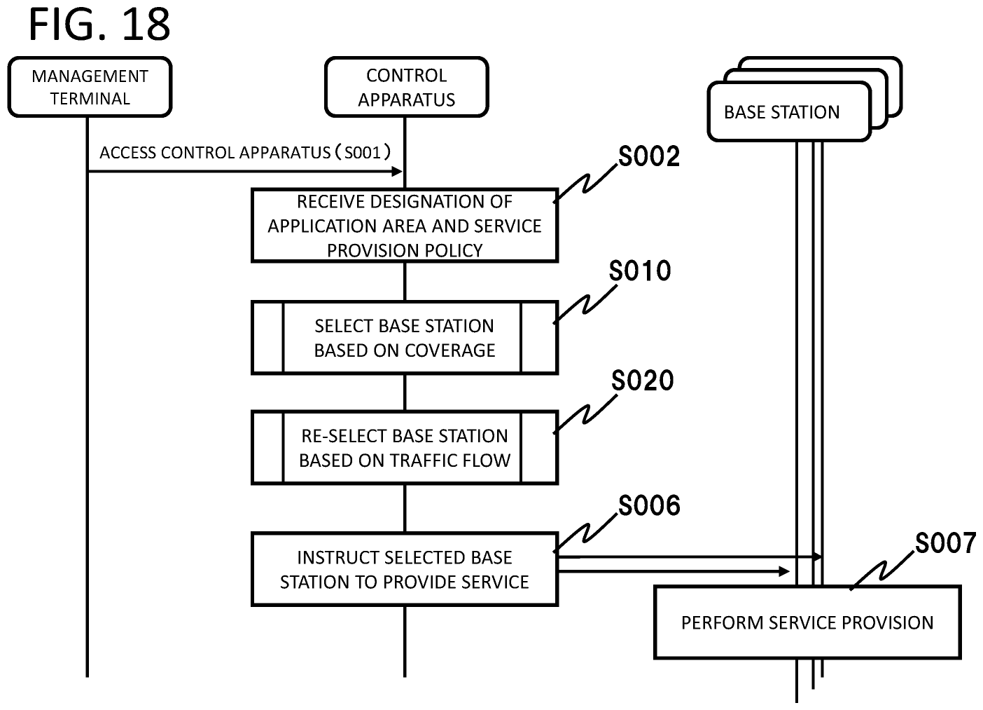

Next, an operation of the present example embodiment will be described in detail with reference to drawings. FIG. 18 is a sequence diagram illustrating an operation of the control apparatus according to the third example embodiment. Step S001 to step S010 as shown in FIG. 18 are the same as the step S001 to step S005 as shown in FIG. 8, explanation thereof will be omitted. At step S010 of FIG. 18, after selection of one or more base stations based on a coverage is finished, next, for road sections to which the traffic flow consideration field is “YES” in the service provision policy, the control apparatus 100b acquires traffic flow information from the traffic control center 300a and determines whether or not to make one or more base stations in the corresponding road sections provide a service based on level of the traffic flow (step S020).

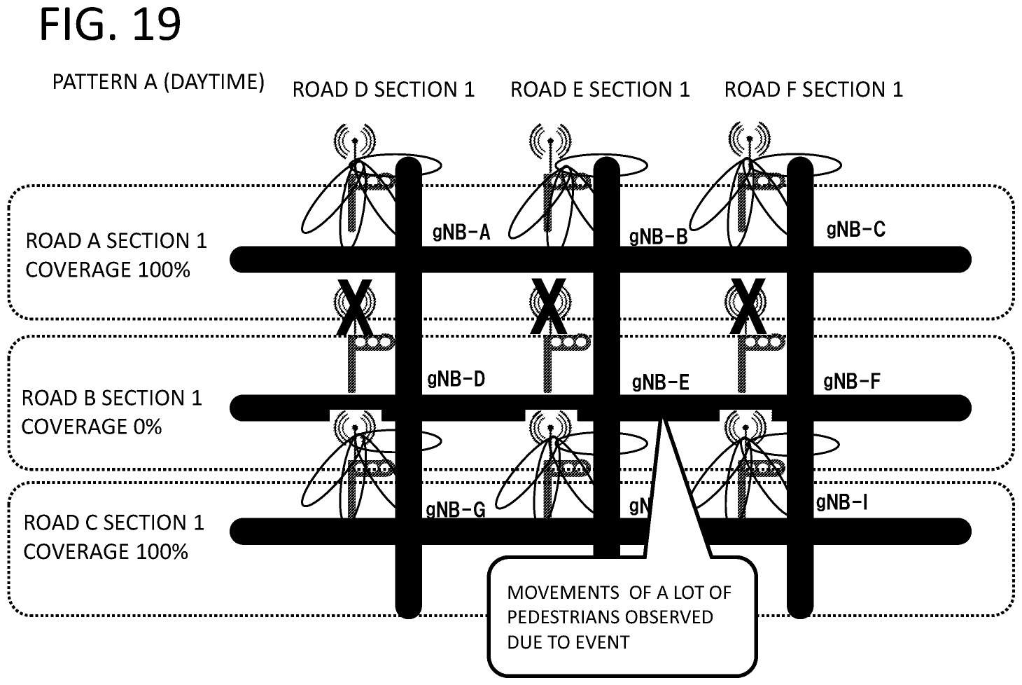

For example, as shown in FIG. 19, it is assumed that it is determined to make the base stations gNB-D to gNB-F of the toad B section 1 suspend provision of a service based on the calculated coverage and a service provision policy. Here, when movements of a lot of pedestrians are observed due to an event between the base stations gNB-E and gNB-F as shown in FIG. 19, the control apparatus 100b determines to make the base station gNB-E and gNB-F provide the service at step S020 of FIG. 18.

Next, the control apparatus 100b instructs the selected base station gNB-D to suspend the service (step S006).

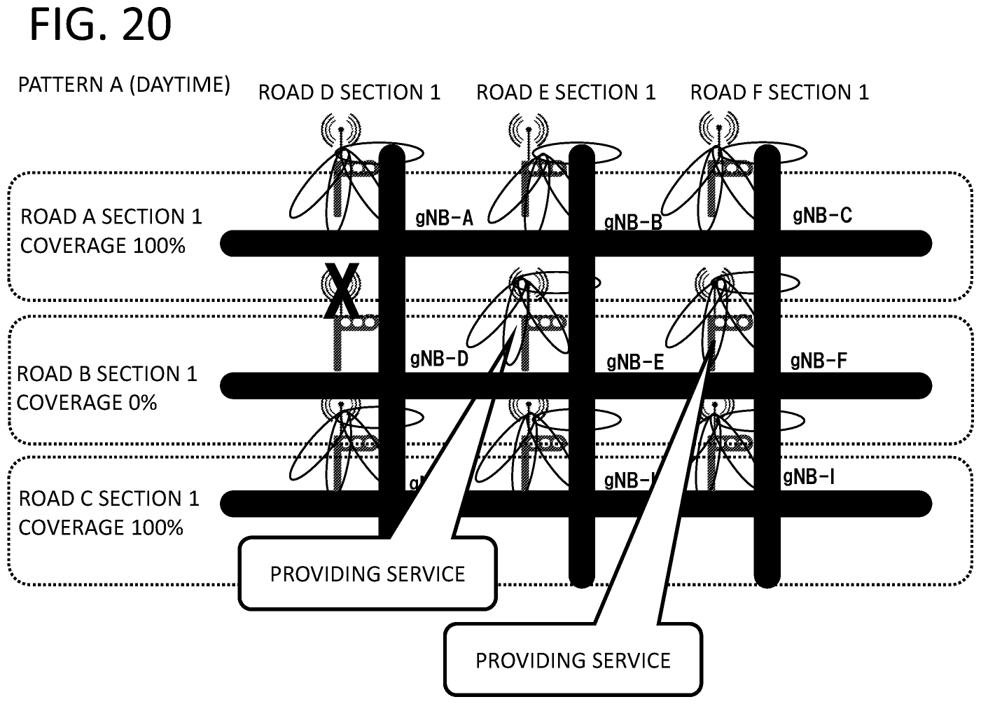

Finally, the base station gNB-D suspends the service according to the instruction from the control apparatus 100b (step S007). By doing this, as shown in FIG. 20, it is possible to make the base stations gNB-E and gNB-F of the road B section 1 provide the service. As a result, it becomes possible to provide pedestrians who reside in a service area of the base stations gNB-E and gNB-F with the service.

The exemplary embodiments of the present invention have been described as above, however, the present invention is not limited thereto.

Further modifications, substitutions, or adjustments can be made without departing from the basic technical concept of the present invention. For example, the configurations of the apparatuses and the elements and the representation modes of the data or the like illustrated in the individual drawings are merely used as examples to facilitate the understanding of the present invention. Thus, the present invention is not limited to the configurations illustrated in the drawings. For example, in the first example embodiment described above, the example in which the one or more base stations are placed at each intersection of grid-like roads has been described but layout of the base stations is not limited thereto. For example, when one base station is located between the intersections, it is possible to calculate a coverage in the same way and to determine whether or not to make the base station provide a service.

For example, in the example embodiment described above, the example in which the base stations are 5G base stations has been described, but the base stations to which the present invention can be applied are not limited to 5G base stations. For example, the present invention can be applied when the service is provided using access points of a wireless LAN (Local Area Network), or the like.

Furthermore, in the example embodiment described above, the example of a configuration in which each base station has a backup power supply is described, but each base station does not necessarily have a backup power supply.

Furthermore, in the example embodiment described above, there may be a case where it is requested to continue to provide a service for emergency vehicles and rescue vehicles. In this case, it is possible to handle the case by providing the control apparatus with a part that detects entry of the emergency vehicles and the rescue vehicles to the service target area. Concretely, when the entry of the emergency vehicles and the rescue vehicles to the service target area is detected, the control apparatus controls to increase the target service coverage or, to switch over a service provision policy to an appropriate service provision policy among a plurality of service provision policies. By doing this, it become possible to continue to provide assistances of passages of these vehicles or communication services in the vehicles.

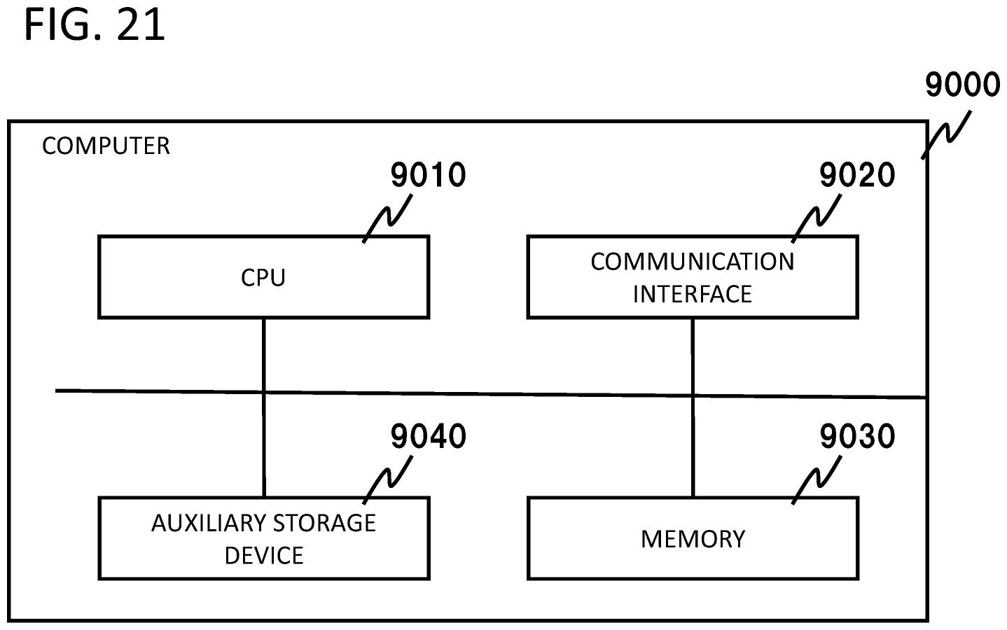

In addition, the procedures described in the above each example embodiment can each be realized by a program causing a computer (9000 in FIG. 21) functioning as the corresponding control apparatus to realize the functions as the corresponding control apparatus. For example, this computer is configured to include a CPU (Central Processing Unit) 9010, a communication interface 9020, a memory 9030, and an auxiliary storage device 9040 in FIG. 21. That is, the CPU 9010 in FIG. 21 executes a service provision state acquisition program and a coverage calculation program.

That is, the individual parts (processing means, functions) of each of the control apparatuses 100, 100a, and 100b as described above can each be realized by a computer program that causes a processor mounted on the corresponding apparatus to execute the corresponding processing described above by using corresponding hardware.

Finally, suitable modes of the present invention will be summarized.

### [Mode 1]

(See the base station control apparatus according to the above first aspect)

### [Mode 2]

The above control apparatus may have a configuration,
wherein the service coverage is calculated using a ratio of a length of the section where the predetermined service is provided to a whole length of the road section.

### [Mode 3]

The above control apparatus may have a configuration,
wherein the base station control apparatus instructs the one or more base stations weather or not to provide the predetermined service in such way that the service coverage becomes to be a predetermined target coverage ratio.

### [Mode 4]

The one or more base stations respectively includes a backup power supply, and
the above control apparatus may have a configuration,
wherein, when a power outage occurs, the base station control apparatus instructs the one or more base stations weather or not to provide the predetermined service in such way that the service coverage becomes to be a second target coverage ratio.

### [Mode 5]

The above control apparatus may have a configuration,
wherein the base station control apparatus further holds a plurality of patterns in which the target coverage rates are set, for the each road section, and
wherein the base station control apparatus determines whether or not the one or more base stations provide the predetermined service by switching over the plurality of patterns.

### [Mode 6]

The above control apparatus may have a configuration,
wherein, as the patterns, the base station control apparatus holds at least a control pattern for weekdays and a control pattern for holidays which can be selectable.

### [Mode 7]

The above control apparatus may have a configuration, wherein, as the patterns, the base station control apparatus holds at least a control pattern for daytime and a control pattern for night-time which can be selectable.

### [Mode 8]

The above control apparatus may have a configuration, further including:
a part that instructs the one or more base stations whether or not to provide the predetermined service based on a traffic flow of the road section.

### [Mode 9]

(See the base station control method according to the above second aspect)

### [Mode 10]

(See the recording medium recording a program according to the above third aspect)

The above modes 9 and 10 can be expanded to the modes 2 to 8 in the same way as the mode 1 is expanded.

The disclosure of each of the above PTLs is incorporated herein by reference thereto and may be used as the basis or a part of the present invention, as needed. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed. In addition, as needed and based on the gist of the present invention, the individual disclosed matters in the above literatures, as a part of the disclosure of the present invention, and partial or entire use of the individual disclosed matters in the above literatures that have been referred to in combination with what is disclosed in the present application, should be deemed to be included in what is disclosed in the present application.

### REFERENCE SIGNS LIST

100, 100a, 100 control apparatus
101 service provision state acquisition part
101a state acquisition part
102, 102a calculation part
103, 103a instruction part
104 base station information storage part
105, 105a service provision policy storage part
106 selection part
107 traffic flow information acquisition part
200 base station (gNB)
201 backup power supply (BAT)
300, 300a traffic control center
9000 computer
9010 CPU
9020 communication interface
9030 memory
9040 auxiliary storage device

What is claimed is:

1. A base station control apparatus, comprising:
at least a processor; and
a memory in circuit communication with the processor,
wherein the processor is configured to execute program instructions stored in the memory to implement:
to acquire a provision state of a predetermined service by one or more base stations in a service target area; and
to instruct the one or more base stations whether or not to provide the predetermined service based on a service coverage which indicates a ratio of one or more areas in which the predetermined service is provided by the one or more base stations for each road section included in the service target area.

2. The base station control apparatus according to claim 1,
wherein the service coverage is calculated using a ratio of a length of the section where the predetermined service is provided to a whole length of the road section.

3. The base station control apparatus according to claim 1,
wherein the base station control apparatus instructs the one or more base stations weather or not to provide the predetermined service in such way that the service coverage becomes to be a predetermined target coverage ratio.

4. The base station control apparatus according to claim 1,
wherein the one or more base stations respectively comprise a backup power supply, and
wherein, when a power outage occurs, the base station control apparatus instructs the one or more base stations weather or not to provide the predetermined service in such way that the service coverage becomes to be a second target coverage ratio.

5. The base station control apparatus according to claim 3,
wherein the base station control apparatus further holds a plurality of patterns in which the target coverage rates are set, for the each road section, and
wherein the base station control apparatus determines whether or not the one or more base stations provide the predetermined service by switching over the plurality of patterns.

6. The base station control apparatus according to claim 5,
wherein, as the patterns, the base station control apparatus holds at least a control pattern for weekdays and a control pattern for holidays which can be selectable.

7. The base station control apparatus according to claim 5,
wherein, as the patterns, the base station control apparatus holds at least a control pattern for daytime and a control pattern for night-time which can be selectable.

8. The base station control apparatus according to claim 1, wherein the processor is configured to execute the program instructions to implement:
to instruct the one or more base stations whether or not to provide the predetermined service based on a traffic flow of the road section.

9. A base station control method, comprising:
by a base station control apparatus which controls one or more base stations,
acquiring a provision state of a predetermined service by the one or more base stations in a service target area; and
instructing the one or more base stations whether or not to provide the predetermined service based on a service coverage which indicates a ratio of one or more areas in which the predetermined service is provided by the one or more base stations for each road section included in the service target area.

10. A computer-readable non-transitory recording medium recording a program, the program causing a computer mounted on a base station control apparatus which controls one or more base stations to perform processings of:
acquiring a provision state of a predetermined service by the one or more base stations in a service target area; and
instructing the one or more base stations whether or not to provide the predetermined service based on a service coverage which indicates a ratio of one or more areas in which the predetermined service is provided by the one or more base stations for each road section included in the service target area.

11. The base station control method according to claim 9,
wherein the service coverage is calculated using a ratio of a length of the section where the predetermined service is provided to a whole length of the road section.

12. The base station control method according to claim 9, further comprising:
by the base station control apparatus,
instructing the one or more base stations weather or not to provide the predetermined service in such way that the service coverage becomes to be a predetermined target coverage ratio.

13. The base station control method according to claim 9,
wherein the one or more base stations respectively comprise a backup power supply, and
further comprising:
when a power outage occurs, by the base station control apparatus,
instructing the one or more base stations weather or not to provide the predetermined service in such way that the service coverage becomes to be a second target coverage ratio.

14. The base station control method according to claim 12, further comprising:
by the base station control apparatus,
further holding a plurality of patterns in which the target coverage rates are set, for the each road section, and
determining whether or not the one or more base stations provide the predetermined service by switching over the plurality of patterns.

15. The base station control method according to claim 14,
as the patterns, by the base station control apparatus,
holding at least a control pattern for weekdays and a control pattern for holidays which can be selectable.

16. The computer-readable non-transitory recording medium recording the program according to claim 10,
wherein the service coverage is calculated using a ratio of a length of the section where the predetermined service is provided to a whole length of the road section.

17. The computer-readable non-transitory recording medium recording the program according to claim 10, the program causing the computer
to instruct the one or more base stations weather or not to provide the predetermined service in such way that the service coverage becomes to be a predetermined target coverage ratio.

18. The computer-readable non-transitory recording medium recording the program according to claim 10,
wherein the one or more base stations respectively comprise a backup power supply, and
the program causing the computer
when a power outage occurs,
to instruct the one or more base stations weather or not to provide the predetermined service in such way that the service coverage becomes to be a second target coverage ratio.

19. The computer-readable non-transitory recording medium recording the program according to claim 17, the program causing the computer
further to hold a plurality of patterns in which the target coverage rates are set, for the each road section, and
to determine whether or not the one or more base stations provide the predetermined service by switching over the plurality of patterns.

20. The computer-readable non-transitory recording medium recording the program according to claim 19, the program causing the computer
as the patterns,
to hold at least a control pattern for weekdays and a control pattern for holidays which can be selectable.
